(19) United States
(12) Patent Application Publication
(10) Pub. No.: US 2016/0121265 A1
(43) Pub. Date: May 5, 2016

(54) GAS DECOMPOSITION FILTER UNIT AND AIR PURIFIER

(71) Applicant: SHARP KABUSHIKI KAISHA, Osaka (JP)

(72) Inventors: Hirofumi KANDA, Osaka-shi (JP); Masashi TAKEMOTO, Osaka-shi (JP)

(21) Appl. No.: 14/890,616

(22) PCT Filed: Oct. 24, 2014
(86) PCT No.: PCT/JP2014/078400

§ 371 Date: Nov. 12, 2015

(30) Foreign Application Priority Data
Feb. 19, 2014 (JP) 2014-029747

(51) Int. Cl. B01D 53/86

(52) U.S. Cl. CPC B01D 53/8678; B01D 2255/802

(57) ABSTRACT

A gas decomposition filter unit (10A) of the present invention includes: a housing (1A) including gas decomposition pellets (3) and having a mesh (5) as a side surface vertical to a direction in which gas flows, which mesh (5) having a mesh size smaller than each of the gas decomposition pellets (3); and a light guide member 4A for causing light having entered from a light source (2) to exit toward the gas decomposition pellets (3), which light guide member 4A is provided along at least one direction so as to extend over a spatial range in which the plurality of gas decomposition pellets (3) are provided along the side surface of the housing.

### TECHNICAL FIELD

The present invention relates to a gas decomposition filter unit and an air purifier each employing a photocatalyst. In particular, the present invention relates to a gas decomposition filter unit and an air purifier each of which can highly efficiently decompose a removal target gas by efficiently irradiating, with light, a spatial range in which a photocatalyst is provided.

### BACKGROUND ART

Conventionally, there have been known air purifiers that employ an adsorbent and a photocatalyst in order to fulfill an air purifying function. Such an air purifier employing an adsorbent and a photocatalyst decomposes a harmful substance by (i) adsorbing the harmful substance with the adsorbent provided in a flow path of air introduced into the air purifier and (ii) irradiating, with light, the photocatalyst that is supported by the adsorbent.

For example, each of Patent Literatures 1 and 2 discloses an air purifier employing an adsorbent and a photocatalyst.

Specifically, Patent Literature 1 discloses, as an example of the air purifier employing an adsorbent and a photocatalyst, an on-board chemical substance removing device. The chemical substance removing device disclosed in Patent Literature 1 is provided with more than one kind of adsorbents depending on harmful substances. The device (i) first adsorbs harmful substances with a deodorization filter which includes an adsorbent and a photocatalyst provided in an air flow path, and (ii) then decomposes the harmful substances by irradiation of the photocatalyst with light emitted from a light source which is provided in the air flow path separately from the deodorization filter.

The above method causes the adsorbent to adsorb a harmful substance from harmful-substance-containing air which comes to the adsorbent while flowing in the air path. Then, the harmful substance having been adsorbed by the adsorbent can be decomposed with the photocatalyst by irradiating, in the air flow path, the catalyst with light emitted from a light source which is provided in front of the deodorization filter.

Meanwhile, Patent Literature 2 discloses an adsorbent which is optically restorable. According to Patent Literature 2, (i) the adsorbent which supports a photocatalyst adsorbs a harmful substance, and then (ii) the photocatalyst is irradiated with light emitted from a light source which is provided on a downstream side in an air flow path, so that the harmful substance which has been adsorbed by the adsorbent is decomposed.

### CITATION LIST

### Patent Literature

### [Patent Literature 1]

Japanese Patent Application Publication Tokukai, No. 2001-232154 (Publication Date: Aug. 28, 2001)

### [Patent Literature 2]

Japanese Patent Application Publication Tokukai, No. 2011-200857 (Publication Date: Oct. 13, 2011)

### SUMMARY OF INVENTION

### Technical Problem

Such conventional gas decomposition filter units and conventional air purifiers disclosed in Patent Literatures 1 and 2 are intended to decompose a harmful substance by irradiating a photocatalyst with light. However, inconveniently, neither one of Patent Literatures 1 and 2 discloses a light irradiation method well-devised in terms of light irradiation efficiency.

That is, there is a demand for a method that allows for more efficient light irradiation because efficiency of decomposition by use of a photocatalyst largely depends on light irradiation intensity. In regard to light irradiation efficiency, in the conventional light irradiation methods disclosed in Patent Literatures 1 and 2, a point light source is provided only at a center or at three positions in a direction in which an adsorbent that supports a photocatalyst is provided. With this configuration, light emitted from the light source(s) cannot sufficiently reach far end portions in the direction in which the adsorbent is provided. This makes light irradiation efficiency insufficient, and may consequently deteriorate efficiency of decomposition of a harmful substance.

The present invention is attained in view of the above problem. An object of the present invention is to provide a gas decomposition filter unit and an air purifier each of which can highly efficiently decompose a removal target gas by efficiently irradiating, with light, a spatial range in which a photocatalyst is provided.

### Solution to Problem

In order to solve the above problem, a gas decomposition filter unit in accordance with an aspect of the present invention is a gas decomposition filter unit for decomposing a removal target gas, the gas decomposition filter unit including: gas decomposition pellets including a supported photocatalyst, the gas decomposition pellets allowing gas which contains the removal target gas to flow in a space between the gas decomposition pellets; a light source for emitting light with which the gas decomposition pellets are irradiated; a housing including the gas decomposition pellets and having a mesh side surface wall at least as a side surface vertical to a direction in which the gas flows, the mesh side surface wall having a mesh size smaller than each of gas decomposition pellets; and a light guide member for causing light having entered from the light source to exit toward the gas decomposition pellets, the light guide member being provided along at least one direction so as to extend over a spatial range in which the gas decomposition pellets are provided along the side surface of the housing.

In order to solve the above problem, an air purifier in accordance with an aspect of the present invention includes the above gas decomposition filter unit.

### Advantageous Effects of Invention

According to an aspect of the present invention, it is possible to provide a gas decomposition filter unit and an air purifier each of which can highly efficiently decompose a removal target gas by efficiently irradiating, with light, a spatial range in which a photocatalyst is provided.

### BRIEF DESCRIPTION OF DRAWINGS

FIG. 1 is a pair of views (a) and (b); (a) of FIG. 1 is a front cross-sectional view illustrating a configuration of a gas decomposition filter unit of Embodiment 1 of the present invention, and (b) of FIG. 1 is a side cross-sectional view illustrating the configuration of the gas decomposition filter unit.

FIG. 2 is a perspective view illustrating the configuration of the gas decomposition filter unit.

FIG. 3 is a perspective view illustrating a configuration of a gas decomposition pellet provided inside a housing of the gas decomposition filter unit.

FIG. 4 is a perspective view illustrating a modified example of the configuration of the gas decomposition pellet provided inside the housing of the gas decomposition filter unit.

FIG. 5 is a perspective view illustrating a configuration of a gas decomposition filter unit of Embodiment 2 of the present invention.

FIG. 6 is a front cross-sectional view illustrating the configuration of the gas decomposition filter unit.

FIG. 7 is a perspective view illustrating a configuration of a gas decomposition filter unit of Embodiment 3 of the present invention.

FIG. 8 is a front cross-sectional view illustrating the configuration of the gas decomposition filter unit.

FIG. 9 is a perspective view illustrating a configuration of a gas decomposition filter unit of Embodiment 4 of the present invention.

FIG. 10 is a front cross-sectional view illustrating the configuration of the gas decomposition filter unit.

FIG. 11 is a perspective view illustrating a configuration of an air purifier of Embodiment 5 of the present invention.

### DESCRIPTION OF EMBODIMENTS

### Embodiment 1

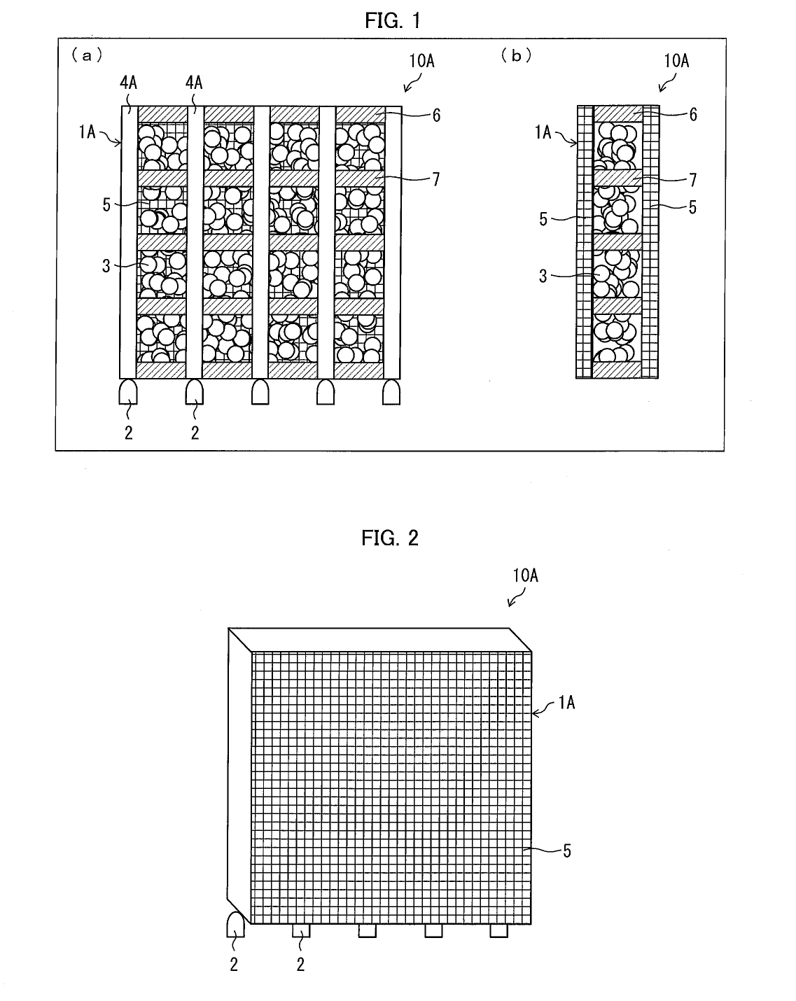

The following discusses Embodiment 1 of the present invention with reference to FIGS. 1 through 4. It should be noted that the embodiments described below are mere examples of the present invention, and by no means limit the present invention.

[Configuration of Gas Decomposition Filter Unit]

The following discusses an outline of a configuration of a gas decomposition filter unit 10A of Embodiment 1 with reference to FIG. 2. FIG. 2 is a perspective view illustrating the configuration of the gas decomposition filter unit 10A.

The gas decomposition filter unit 10A is configured such that light is emitted from a light source 2 provided below a housing 1A so that the light may enter the housing 1A (see FIG. 2). In Embodiment 1, a plurality of light sources 2 is provided. Alternatively, a single light source 2 can be provided in Embodiment 1. In such a case, light emitted from the single light source 2 may be distributed by light guiding. Further, the light source 2 is provided outside the housing 1A in Embodiment 1, but can be provided inside the housing 1A. Even in such a case, an essential effect of the present invention will not be influenced.

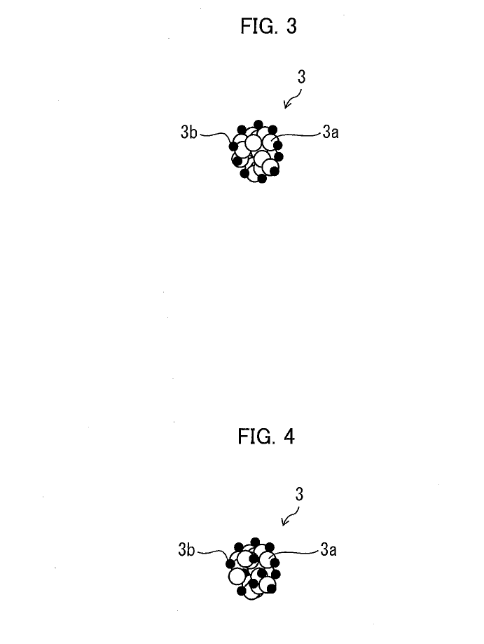

Next, the following discusses in detail the configuration of the gas decomposition filter unit 10A with reference to (a) and (b) of FIG. 1 and FIG. 3. (a) of FIG. 1 is a front cross-sectional view illustrating the configuration of the gas decomposition filter unit 10A of Embodiment 1. (b) of FIG. 1 is a side cross-sectional view illustrating the configuration of the gas decomposition filter unit 10A.

In the gas decomposition filter unit 10A of Embodiment 1, the housing 1A includes (i) two or more light guide members 4A which are vertically provided, (ii) meshes 5 each of which serves as a mesh side surface wall and which form front and back surfaces of the housing 1A, (iii) outer walls 6 which form top and bottom surfaces of the housing 1A, and (iv) partitions 7 for separating gas decomposition pellets 3 (which will be described later) into groups of gas decomposition pellets provided in respective layers formed by the partitions 7 (see (a) and (b) of FIG. 1). Note that in the gas decomposition filter unit 10A of Embodiment 1, the number of the light guide members 4A is five and the number of the partitions 7 is three, but these numbers are not limited thereto. Further, in Embodiment 1, the light guide members 4A are vertically provided also at right and left ends of the housing 1A (see (a) of FIG. 1), but the right and left ends of the housing 1A can alternatively be the outer walls 6 forming right and left side surfaces. In view of light irradiation efficiency of the gas decomposition pellets 3, it is preferable that the light guide members 4A be vertically provided also at the right and left ends of the housing 1A.

In the gas decomposition filter unit 10A of Embodiment 1, the gas decomposition pellets 3 are provided in spaces, in the housing 1A, each surrounded by the light guide members 4A, the meshes 5, and the partitions 7 or a combination of one of the partitions 7 and one of the outer walls 6.

The gas decomposition pellets 3 each have a particle diameter that is larger than a mesh size of the meshes 5.

A specific configuration of the gas decomposition pellet 3 is discussed below with reference to FIGS. 3 and 4. FIG. 3 is a perspective view illustrating a configuration of the gas decomposition pellet 3 to be provided inside the housing 1A of the gas decomposition filter unit 10A. FIG. 4 is a perspective view illustrating a modified example of the configuration of the decomposition pellet 3 provided inside the housing 1A of the gas decomposition filter unit 10A.

The gas decomposition pellet 3 of Embodiment 1 is composed of particles of an adsorbent 3a and particles of a photocatalyst 3b that are agglomerated and molded into pellets. Here, the adsorbent 3a supports the photocatalyst 3b.

The adsorbent 3a of Embodiment 1 is made of, for example, active carbon, zeolite, sepiolite, or a mixture thereof with an additive. A material of the adsorbent 3a is selected as appropriate depending on a kind of gas to be adsorbed. Accordingly, the adsorbent 3a of the present invention is not necessarily made of active carbon, zeolite, sepiolite, or a mixture thereof with an additive, and can be made of another material. In such a case, since the adsorbent 3a is to be used in combination with the photocatalyst 3b, it is more advantageous in terms of light utilization efficiency that the adsorbent 3a be made of a transparent material or white material like zeolite, rather than a black material such as active carbon.

The photocatalyst 3b of Embodiment 1 is made of, for example, titanium dioxide (TiO₂), tungsten trioxide (WO₃), or a mixture thereof with an additive. A material of the photocatalyst 3b of the present invention is not necessarily limited to the above substances. Meanwhile, the photocatalyst 3b needs to be a visible light responsive photocatalyst for a reason that will be described later.

A molding method of the gas decomposition pellet 3 is not particularly limited. The gas decomposition pellet 3 may be formed through pelletization using a ring die pellet mill or a flat die pellet mill or pelletization using a briquetting machine.

In Embodiment 1, the adsorbent 3a is used as a support. However, the support in the present invention is not necessarily limited to the adsorbent 3a. The support can be made of a mixture of the adsorbent 3a with another substance. For example, in molding of the gas decomposition pellet 3, a binder can be added as appropriate as the another substance. In such a case, an inorganic binder is suitable because it is hardly influenced by decomposition by use of the photocatalyst 3b.

When molded, the gas decomposition pellet 3 can be arranged such that the photocatalyst 3b partially covers a surface of a mass of the adsorbent 3a (see FIG. 3). Alternatively, the gas decomposition pellet 3 can be arranged such that the adsorbent 3b and the photocatalyst 3a are kneaded so that the photocatalyst 3b may be present not only on the surface of the mass but also inside the mass of the adsorbents 3a (see FIG. 4).

For example, in a case where the adsorbent 3a is made of a material, such as active carbon, which does not transmit light or a material that reflects light, it is preferable in terms of a high light irradiation efficiency that the photocatalyst 3b be present only on the surface of the mass of the adsorbent 3a (see FIG. 3). Alternatively, in a case where the adsorbent 3a is made of a material, such as zeolite, that transmits light, it is preferable in terms of a high light irradiation efficiency that the photocatalyst 3b be present not only on the surface of the mass but also inside the mass of the adsorbents 3a (see FIG. 4).

The light source 2 of Embodiment 1 is provided at least below a bottom end in a height direction of each of the light guide members 4A. However, the light source 2 is not necessarily provided at the bottom end and can be provided to a top end in the height direction of the light guide member 4A. Alternatively, the light source 2 can be provided to an end on a back surface side of the housing 1A.

The light source 2 only needs to be a visible-light source. The light source 2 can be, for example, a light emitting diode (LED). An emission spectrum of the light source 2 does not necessarily have a single peak, but preferably has a peak in the vicinity of an absorption wavelength of the photocatalyst 3b used in the gas decomposition pellets 3.

The light guide members 4A each cause light having entered from the light source 2 to exit toward the gas decomposition pellets 3 (see (a) of FIG. 1). The light guide member 4A of Embodiment 1 is provided so as to extend (i) along at least one direction in which the gas decomposition pellets 3 are provided, and (ii) over a spatial range in which the gas decomposition pellets 3 are provided. Further, the light guide members 4A of Embodiment 1 each cause light to exit perpendicularly to the gas decomposition pellets 3. In Embodiment 1, the light guide member 4A is provided in a vertical direction. However, the light guide member 4A of the present invention is not necessarily provided in the vertical direction and can be provided in a horizontal direction.

Further, the light guide members 4A of Embodiment each have, for example, a flat-plate shape, and are provided in such a manner that a plurality of flat plates are arranged to be parallel to a gas flow direction. The light guide members 4A of Embodiment 1 therefore each have at least a function of not a point light source but a linear light source.

It is important that the light guide members 4A have a high light transmittance in the vicinity the absorption wavelength of the photocatalyst 3b used in the gas decomposition pellets 3. However, acryl and polycarbonate that are each typically used as a material of light guide members have a low UV transmittance. Therefore, in a case where (i) the photocatalyst 3b to be used in the gas decomposition pellets 3 is a visible light responsive photocatalyst and (ii) the light source 2 is a visible-light source, it is possible to use, for the light guide members 4A, a typical light guide material such as acryl and polycarbonate.

The light guide members 4A each have a surface which is formed to be uneven as appropriate so as to cause light having entered from the light source 2 to exit toward the gas decomposition pellets 3. In order to prevent light from leaking out from the housing 1A, the light guide members 4A provided as right and left walls of the housing 1A at right and left ends of the housing 1A can each have an outer surface which has been given light reflectivity by surface treatment. In extreme cases, members serving as side walls of the housing 1A can be identical in material to the outer walls 6 rather than to the light guide members 4A. In such a case, it is preferable that an outer surface of each of the outer walls 6 has been given light reflectivity by surface treatment.

As described earlier, the meshes 5 each only need to have a mesh size smaller than the particle diameter of the gas decomposition pellet 3. The mesh 5 is not particularly limited in material, but preferably is made of an inorganic material because the mesh 5 made of an inorganic material is hardly influenced by decomposition by use of the photocatalyst 3b. The mesh 5 is attached to the front and back surfaces of the housing 1A (see (b) of FIG. 1). This prevents the gas decomposition pellets 3 from going out of the housing 1A.

The partitions 7 divide an inner space of the housing 1A into smaller spaces, mainly for the purpose of distributing the gas decomposition pellets 3 in the housing 1A as evenly as possible. Accordingly, in a case where surfaces of the partitions 7 and respective inner surfaces of the outer walls 6 are given light reflectivity by surface treatment, it is possible to prevent light utilization efficiency from deteriorating. Further, the partitions 7 and the outer walls 6 can be made of a transparent material or the same material as that of the light guide members 4A.

[Effects of Gas Decomposition Filter Unit]

The following discusses effects of the gas decomposition filter unit 10A having the above-described configuration.

The front and back surfaces of the housing 1A are made of the meshes 5 (see (b) of FIG. 1 and FIG. 2). This prevents the gas decomposition pellets 3 from going out of the housing 1A, but allows gas to freely enter and exit the housing 1A.

Examples of a harmful removal target gas to be decomposed encompasses a volatile organic compound (VOC) gas such as formaldehyde gas and acetaldehyde gas, ammonium gas, and tobacco smoke. These organic gases that mainly cause offensive odor are adsorbed by the adsorbent 3a of the gas decomposition pellet 3 inside the housing 1A. When the removal target gas has been adsorbed by the adsorbent 3a, the removal target gas inside the housing 1A decreases in concentration, which produces a concentration gradient. This concentration gradient causes more gas to come inside the housing 1A, and consequently leads to further adsorption of more removal target gas. Here, in a case where the removal target gas is moved only by the concentration gradient at a moving speed that is too slow, it is also possible to actively feed more removal target gas into the housing 1A by additionally making an air stream with a fan or the like. In any case, the removal target gas is thus adsorbed by the adsorbent 3a of the gas decomposition pellets 3. Note that the gas decomposition pellets 3 and the light guide members 4A are provided parallel to a gas flow path (see (a) of FIG. 1), so that the light guide members 4A never block a gas flow. The light guide members 4A therefore do not deteriorate adsorption efficiency of the gas decomposition pellets 3.

The light sources 2 that are provided at ends of the light guide members 4A (see (a) of FIG. 1) emit light, and the emitted light enters the light guide members 4A which face the light sources 2, respectively. The light then propagates in the light guide members 4A and exits from a surface of each of the light guide members 4A. Some of the light having exited is directly used for light irradiation of the decomposition pellets 3, or used for light irradiation of the decomposition pellets 3 after reflected by the surfaces of the partitions 7 or inner surfaces of the outer walls 6.

As such, with the light guide members 4A which are each provided so as to extend (i) along a direction in which the gas decomposition pellets 3 are provided and (ii) over a spatial range in which the gas decomposition pellets 3 are provided, (a) light emitted from the light sources 2 can be guided, in a less attenuated state, to the immediate vicinity of the gas decomposition pellets 3, and (b) the gas decomposition pellets 3 can be irradiated with the light at a short distance. This consequently makes it possible to improve a gas decomposition performance of the photocatalyst 3b of the gas decomposition pellets 3.

The gas decomposition pellets 3 generate active species as a result of light irradiation on the photocatalyst 3b. These active species are highly oxidative, and thereby decompose a harmful gas. However, each of the active species has a short life. Accordingly, in a case where a harmful gas is not present at a high concentration in the vicinity of positions where the active species are generated, the active species disappear without sufficiently exerting effects on the harmful gas.

In the gas decomposition pellets 3 of Embodiment 1, the adsorbent 3a to which a large amount of harmful gas stays adsorbed is present in the immediate vicinity of the photocatalyst 3b. Therefore, the active species having been generated by light irradiation on the photocatalyst 3b work effectively for decomposition of the harmful gas (i.e., the removal target gas), so that the harmful gas can be highly efficiently decomposed.

As described above, the gas decomposition filter unit 10A of Embodiment 1 is provided with (i) the gas decomposition pellets 3 where the photocatalyst 3b is supported and (ii) the light sources 2 for emitting light with which the gas decomposition pellets 3 are to be irradiated. The gas decomposition filter unit 10A thereby decomposes the removal target gas which is contained in gas flowing in a space between the gas decomposition pellets 3. The gas filter unit 10A further includes (iii) the housing 1A and (iv) the light guide members 4A. The housing 1A is provided therein with the gas decomposition pellets 3 and is also provided with the meshes 5 as mesh side surface walls each of which provides a side surface vertical to a gas flow direction. The mesh side surface walls each at least have a mesh size smaller than each of the gas decomposition pellets 3. The light guide members 4A each are provided so as to extend over a spatial range in which the gas decomposition pellets 3 are provided along the side surfaces of the housing 1A. The light guide members 4A cause light emitted from the light sources 2 to exit toward the gas decomposition pellets 3.

According to the above configuration, the gas filter unit 10A further includes the housing 1A that is provided therein with the gas decomposition pellets 3 and is also provided with the meshes 5 each of which provides a side surface vertical to a gas flow direction. The meshes 5 each at least have a mesh size smaller than each of the gas decomposition pellets 3. Therefore, gas enters from the side surfaces of the housing 1A through the meshes 5 and flows in a space between the gas decomposition pellets 3.

The gas decomposition filter unit 10A of Embodiment 1 further includes the light guide members 4A each of which is provided so as to extend over a spatial range in which the gas decomposition pellets 3 are provided along the side surfaces of the housing 1A. The light guide members 4A cause light emitted from the light sources 2 to exit toward the gas decomposition pellets 3.

According to the above configuration, light having entered into the light guide members 4A from the light source 2 is caused to exit from respective exit surfaces of the light guide members 4A which surfaces face the gas decomposition pellets 3, while being guided inside the light guide members 4A. Since the light guide members 4A are provided along at least one direction so as to extend over the spatial range in which the gas decomposition pellets 3 are provided, the light is caused to exit from the exit surfaces of the light guide members 4A thoroughly from one end to the other end along the direction in which the gas decomposition pellets 3 are provided.

Conventionally, light was emitted from a point light source provided at, for example, a central position between ends along a direction in which gas decomposition pellets 3 are provided. This resulted in a low light irradiation intensity at the ends along the direction in which the gas decomposition pellets are provided.

In contrast, in Embodiment 1 where the light guide members 4A are used, the light guide members 4A irradiate the gas decomposition pellets 3 with light perpendicular to the gas decomposition pellets 3, thoroughly in the direction in which the gas decomposition pellets 3 are provided. From this, the light guide members 4A of Embodiment 1 each are not a point light source but a linear light source which extends in a vertical direction or in a horizontal direction. This makes it possible to irradiate all of the gas decomposition pellets 3 with intense light, thereby leading to a high light irradiation efficiency.

Therefore, it is possible to provide the gas decomposition filter unit 10A which can highly efficiently decompose the removal target gas by efficiently irradiating, with light, a spatial range in which a photocatalyst is provided.

In the gas decomposition filter unit 10A of Embodiment 1, the gas decomposition pellets 3 further include the adsorbent 3a and are formed by integrally forming the adsorbent 3a and the photocatalyst 3b into pellets in such a manner that the adsorbent 3a and the photocatalyst 3b are in contact with each other.

This makes it possible to (i) adsorb, with the adsorbent 3a, the removal target gas contained in gas which flows in a space between the gas decomposition pellets 3 and (ii) decompose the removal target gas with the photocatalyst 3b. Since the gas decomposition pellets 3 are formed by integrally forming the adsorbent 3a and the photocatalyst 3b into pellets in such a manner that the adsorbent 3a and the photocatalyst 3b are in contact with each other, each of the gas decomposition pellets 3 is in a mass form. This allows the meshes 5 of the housing 1A to have a large mesh size, and therefore makes a gas flow in the space between the gas decomposition pellets 3 smoother.

Therefore, it is possible to provide the gas decomposition filter unit 10A which can highly efficiently decompose the removal target gas.

In the gas decomposition filter unit 10A of Embodiment 1, the adsorbent 3a is made of active carbon, zeolite, sepiolite, or a mixture containing at least one of active carbon, zeolite, and sepiolite.

For example, active carbon has an excellent performance in adsorbing many kinds of gas such as benzene gas, lavatory odor, and acetic acid gas. Zeolite and sepiolite have an excellent performance in adsorbing gas, water, etc., and have been used as deodorizing agents.

Therefore, use of active carbon, zeolite, sepiolite, or a mixture containing at least one of active carbon, zeolite, and sepiolite for the adsorbent 3a makes it possible to provide the gas decomposition filter unit 10A which can highly efficiently decompose the removal target gas.

In the gas decomposition filter unit 10A of Embodiment 1, the photocatalyst 3b is made of titanium dioxide (TiO₂), tungsten trioxide (WO₃), or a mixture containing at least one of titanium dioxide (TiO₂) and tungsten trioxide (WO₃).

For example, titanium dioxide (TiO₂) has a photocatalytic function with which a VOC gas in the air can be removed by light irradiation and/or offensive odor of ammonium, tobacco, etc. can be decomposed by light irradiation. Tungsten trioxide (WO₃) has a photocatalytic function with which a hard-to-decompose VOC gas can be completely oxidized and decomposed.

Therefore, use of titanium dioxide (TiO₂), tungsten trioxide (WO₃), or a mixture containing at least one of titanium dioxide (TiO₂) and tungsten trioxide (WO₃) makes it possible to provide the gas decomposition filter unit 10A which can highly efficiently decompose the removal target gas.

In the gas decomposition filter unit 10A of Embodiment 1, the light guide members 4A each have a plate shape.

According to the above configuration, the light guide members 4A having a flat-plate shape are provided so as to be parallel to a gas flow direction. Therefore, the light guide members 4A (i) does not oppose to a gas flow and (ii) serves as a surface light source with respect to the gas decomposition pellets 3. This makes it possible to irradiate, with light, a spatial range in which a photocatalyst is provided, throughout the spatial range not only in a height direction but also in a depth direction.

Therefore, it is possible to provide the gas decomposition filter unit 10A which can more highly efficiently decompose the removal target gas.

### Embodiment 2

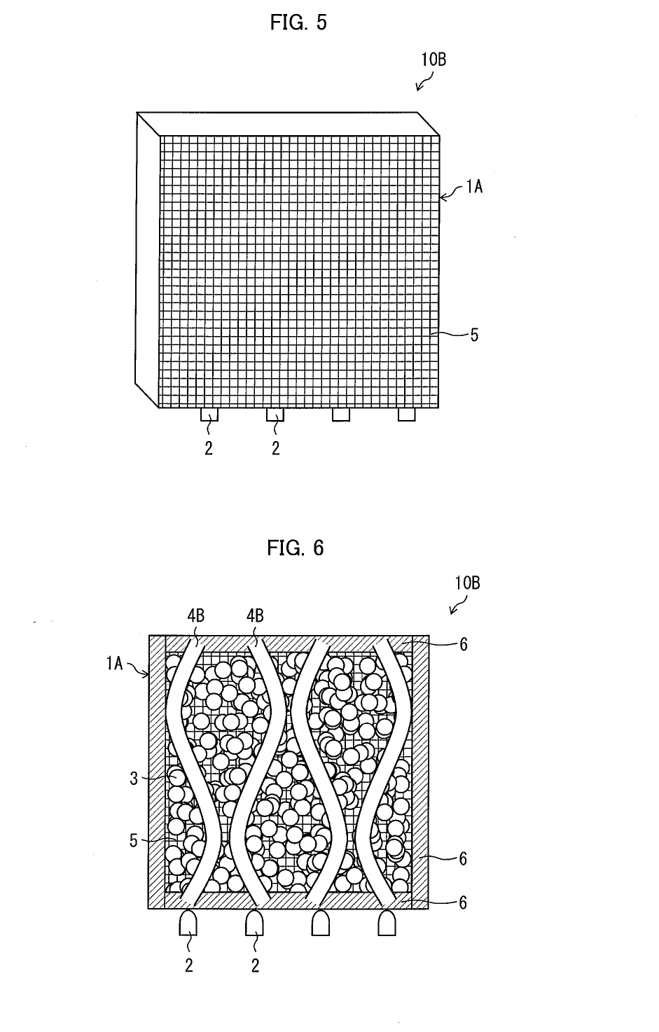

The following discusses Embodiment 2 of the present invention with reference to FIGS. 5 and 6. Note that configurations other than those described in Embodiment 2 are identical to those described in Embodiment 1. For convenience of description, members having the functions identical to those illustrated in the drawings of Embodiment 1 are given the identical reference signs, and descriptions on such members are omitted.

The gas decomposition filter unit 10A of Embodiment 1 is provided with the light guide members 4A having a flat-plate shape. In contrast, light guide members 4B of a gas decomposition filter unit 10B of Embodiment 2 has a wavy-plate shape.

A configuration of the gas decomposition filter unit 10B of Embodiment 2 is discussed below with reference to FIGS. 5 and 6. FIG. 5 is a perspective view illustrating the configuration of the gas decomposition filter unit 10B of Embodiment 2. FIG. 6 is a front cross-sectional view illustrating the configuration of the gas decomposition filter unit 10B.

The gas decomposition filter unit 10B of Embodiment is substantially identical in appearance to the gas decomposition filter unit 10A of Embodiment 1 (see FIG. 5). Further, constituent components in the gas decomposition filter unit 10B are also substantially identical to those of the gas decomposition filter unit 10A of Embodiment 1 (see FIG. 6).

That is, the gas decomposition filter unit 10B is provided with a light source 2, gas decomposition pellets 3, light guide members 4B, meshes 5 as mesh side surface walls, and outer walls 6 which form top and bottom surfaces and side surfaces of the gas decomposition filter unit 10B (see FIG. 6). The gas decomposition pellets 3 each have a particle diameter larger than a mesh size of the meshes 5. The light guide members 4B each are provided so as to cause light having entered from the light source 2 to exit toward the gas decomposition pellets 3.

The housing 1A is composed of the light guide members 4B, the meshes 5, and the outer walls 6. The gas decomposition pellets 3 are provided in spaces, inside the housing 1A, each surrounded by the light guide members 4B, the meshes 5, and the outer walls 6.

In Embodiment 2, however, the light guide members each 4B have a wavy-plate shape. In Embodiment 2, the light guide members 4B are provided in such a manner that phases of adjacent light guide members 4B are shifted from each other, and thereby divide an inner space of the housing 1A into smaller spaces. This makes it possible to eliminate the need for the partitions 7 which are provided in the gas decomposition filter unit 10 A of Embodiment 1 so as to divide the inner space of the housing 1A into smaller spaces. Further, the outer walls 6 of Embodiment 2 not only constitute side walls of the housing 1A so as to form an outer shape of the housing 1A, but also reflect light so as to prevent light from leaking out from the housing 1A.

The above configuration makes it possible to yield the same effects as those yielded by Embodiment 1, with use of fewer components.

As such, the gas decomposition filter unit 10B of Embodiment 2 includes the light guide member 4B having a wavy-plate shape.

In order to stack the gas decomposition pellets 3 inside the housing 1A at an even density in a height direction in the gas decomposition filter unit 10A of Embodiment 1, it is preferable to divide the inner space of the housing 1A into layers. However, since the light guide members 4A have a flat-plate shape in the gas decomposition filter unit 10A, it is necessary to provide the partitions 7 so as to divide the inner space of the housing 1A into layers. This decreases a filling ratio at which the housing 1A is filled with the gas decomposition pellets 3.

On the other hand, in Embodiment 2, the light guide members 4B have a wavy-plate shape. The light guide members 4B having the wavy-plate shape can serve as substitutes for the partitions 7.

Therefore, it is possible to provide the gas decomposition filter unit 10B which can highly efficiently decompose the removal target gas without decreasing a filling ratio at which the housing 1A is filled with the gas decomposition pellets 3.

### Embodiment 3

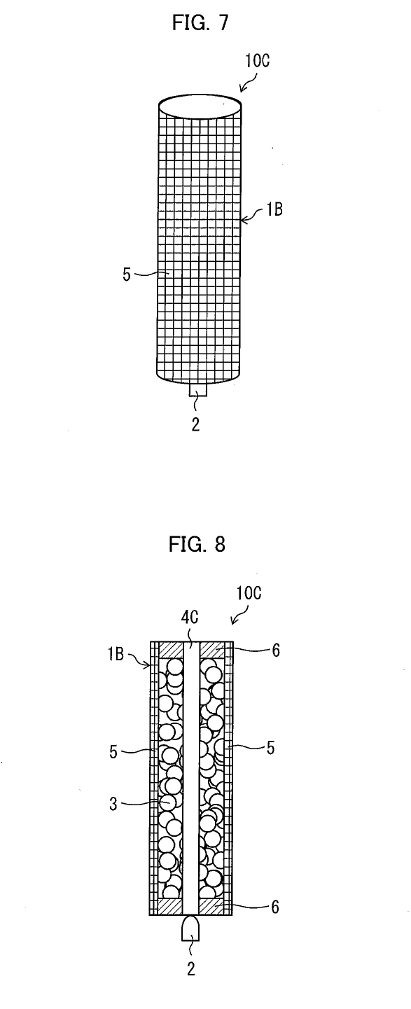

The following discusses Embodiment 3 of the present invention with reference to FIGS. 7 and 8. Note that configurations other than those described in Embodiment 3 are identical to those described in Embodiments 1 and 2. For convenience of description, members having the functions identical to those illustrated in the drawings of Embodiments 1 and 2 are given the identical reference signs, and descriptions on such members are omitted.

In the gas decomposition filter units 10A and 10B of Embodiments 1 and 2, the housing 1A has a rectangular parallelepiped shape. In contrast, a gas decomposition filter unit 10C of Embodiment 3 includes a housing 1B having a cylindrical shape.

A configuration of the gas decomposition filter unit 10C of Embodiment 3 is discussed below with reference to FIGS. 7 and 8. FIG. 7 is a perspective view illustrating the configuration of the gas decomposition filter unit 10C of Embodiment 3 of the present invention. FIG. 8 is a front cross-sectional view illustrating the configuration of the gas decomposition filter unit 10C.

The gas decomposition filter unit 10C of Embodiment 3 differs in appearance from the gas decomposition filter units 10A and 10B of Embodiments 1 and 2, in that the housing 1B of the gas decomposition filter unit 10C of Embodiment 3 has not a rectangular parallelepiped shape but a cylindrical shape (see FIG. 7).

Constituent components in the gas decomposition filter unit 10C are substantially identical to those of the gas decomposition filter units 10A and 10B of Embodiments 1 and 2. That is, the gas decomposition filter unit 10C includes a light source 2, gas decomposition pellets 3, a light guide member 4C, a mesh 5 which serves as a mesh side surface wall, and outer walls 6 which form top and bottom surfaces of the gas decomposition filter unit 10C (see FIG. 8). The gas decomposition pellets 3 each have a particle diameter that is larger than a mesh size of the mesh 5. The light guide member 4C is provided so as to cause light having entered from the light source 2 to exit toward the gas decomposition pellets 3. The housing 1B includes the light guide member 4C, the mesh 5, and the outer walls 6. The gas decomposition pellets 3 are provided in a space surrounded by the light guide member 4C, the mesh 5, and the outer walls 6.

In the gas decomposition filter unit 10C of Embodiment 3, the housing 1B has a cylindrical shape whose side surface is formed by the mesh 5 and whose top and bottom surfaces are formed by the outer walls 6. The light guide member 4C has a pillar shape and is provided along an axis of the cylindrical shape of the housing 1B. That is, in Embodiment 3, only one light guide member 4C is provided. Then, it is preferable that the light source 2 be provided at one end of the light guide member 4C or, alternatively, at both ends of the light guide member 4C. Note that FIG. 8 illustrates an example in which a single light source 2 is provided.

Since only a single guide member 4C is provided in Embodiment 3, the cylindrical shape of the housing 1B cannot be very large in diameter. This is because the intensity of light with which the gas decomposition pellets 3 are irradiated decreases as a distance from the light guide member 4C increases. This may result in lower gas decomposition efficiency.

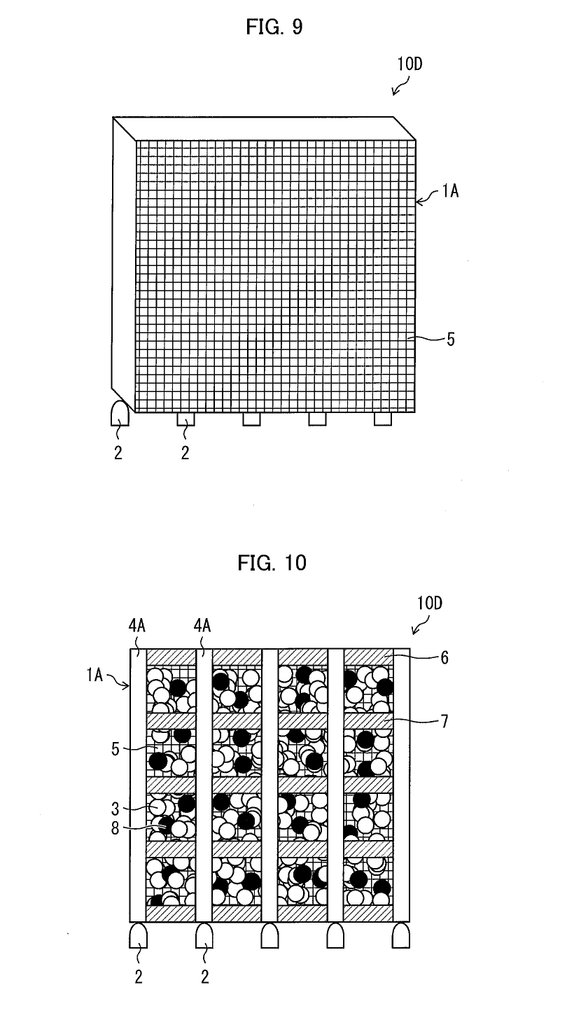

Since the cylindrical shape of the housing 1B cannot be very large in diameter, an inner space of the housing 1B is also not very large. Therefore, even with no partition 7 for dividing the inner space of the housing 1B, the density of the gas decomposition pellets 3 will not largely vary depending on positions inside the housing 1B. Note that FIG. 9 illustrates an example in which the housing 1B includes no partition 7 for dividing the inner space of the housing 1B into small spaces.

In Embodiment 3, the light guide member 4C has a pillar shape and the gas decomposition pellets 3 are present around the light guide member 4C. This makes it possible to irradiate the gas decomposition pellets 3 with light without loss caused by, for example, reflection, which light has exited from the light guide member 4C. Therefore, it is possible to efficiently decompose a harmful gas, i.e., a removal target gas in a reduced space.

As such, in the gas decomposition filter unit 10C of Embodiment 3, the light guide member 4C has a pillar shape and the housing 1B has a cylindrical shape.

This makes it possible to provide the light guide member 4C having a pillar shape along an axis of a cylindrical shape of the housing 1B. The gas decomposition pellets 3 are thus present around the light guide member 4 having a pillar shape. This makes it possible to irradiate the gas decomposition pellets 3 with light without loss caused by, for example, reflection which light has been exited from the light guide member 4C.

Therefore, it is possible to provide the gas decomposition filter unit 10C which can highly efficiently decompose the removal target gas in a reduced space.

### Embodiment 4

The following discusses still another embodiment of the present invention with reference to FIGS. 9 and 10. Note that configurations other than those described in Embodiment 4 are identical to those described in Embodiments 1 through 3. For convenience of description, members having the functions identical to those illustrated in the drawings of Embodiments 1 through 3 are given the identical reference signs, and descriptions on such members are omitted.

In the gas decomposition filter units 10A, 10B, and 10C of Embodiments 1 through 3, only the gas decomposition pellets 3 are provided inside the housing 1A and 1B. In contrast, a gas decomposition filter unit 10D of Embodiment 4 includes not only gas decomposition pellets 3 but also metallic particles 8.

A configuration of the gas decomposition filter unit 10D of Embodiment 4 is discussed below with reference to FIGS. 9 and 10. FIG. 9 is a perspective view illustrating the configuration of the gas decomposition filter unit 10D of Embodiment 4. FIG. 10 is a front cross-sectional view illustrating the configuration of the gas decomposition filter unit 10D.

The gas decomposition filter unit 10D of Embodiment is substantially identical in appearance to the gas decomposition filter units 10A and 10B of Embodiments 1 and 2 (see FIG. 9).

The gas decomposition filter unit 10D of Embodiment 4 is also identical to the gas decomposition filter units 10A and 10B of Embodiments 1 and 2 in constituent components inside the housings 1A and 1B (see FIG. 10).

That is, the gas decomposition filter unit 10D includes light sources 2, gas decomposition pellets 3, and, for example, light guide members 4A, meshes 5, outer walls 6, and partitions 7. The gas decomposition pellets 3 each have a particle diameter larger than a mesh size of the meshes 5. The light guide members 4A are each provided so as to cause light having entered from the light source to exit toward the gas decomposition pellets 3. The housing 1A includes the light guide members 4A, the meshes 5, the outer walls 6, and the partitions 7. The gas decomposition pellets 3 are provided in spaces each surrounded by the light guide members 4A, the meshes 5, and the partitions 7 or one of the outer walls 6 and one of the partitions 7.

In Embodiment 4, however, the housing 1A is provided therein with the metallic particles 8 together with the gas decomposition pellets 3.

The metallic particles 8 can be made of any metal, provided that the metal has a high light reflectance in the vicinity of an absorption wavelength of a photocatalyst 3b included in the gas decomposition pellets 3. The metallic particles 8 can be made of, for example, aluminum or silver. Further, the metallic particles 3 have a particle size similar to that of the gas decomposition pellets 3, so that the metallic particles 8 have a particle size smaller than a mesh size of the meshes 5.

As such, the metallic particles 8 are provided inside the housing 1A together with the gas decomposition pellets 3. As a result, the metallic particles 8 reflect light having exited from the light guide members 4A. This makes it possible to reduce a risk that the gas decomposition pellets 3 relatively far from the light guide members 4A are hidden behind other gas decomposition pellets 3 and thereby cannot be irradiated with light.

The above configuration makes it possible to increase an intensity of light with which the gas decomposition pellets 3 are to be irradiated. This allows for highly efficient decomposition of a harmful gas.

As such, in the gas decomposition filter unit 10D of Embodiment 4, the metallic particles 8 are provided inside the housing 1A together with the gas decomposition pellets 3. This allows the light from the light guide member 4C to be reflected by the metallic particles 8, so that the light for irradiation can reach all the gas decomposition pellets 3 far from the light guide members 4C.

Therefore, it is possible to provide the gas decomposition filter unit 10D which can highly efficiently decompose a removal target gas by efficiently irradiating, with light, a spatial range in which a photocatalyst is provided.

The above description dealt with the gas decomposition filter unit 10D obtained by mixing the metallic particles 8 together with the gas decomposition pellets 3 in the gas decomposition filter unit 10A of Embodiment 1. However, the present invention is not limited to this configuration. Alternatively, the metallic particles 8 can be mixed and used with the gas decomposition pellets 3 in each of the gas decomposition filter units 10B and 10C of Embodiments 2 and 3.

### Embodiment 5

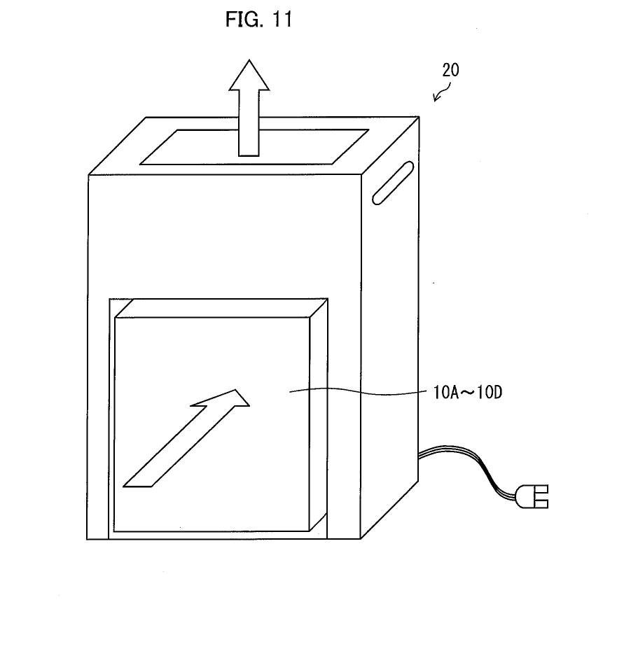

The following discusses Embodiment 5 of the present invention below with reference to FIG. 11. Note that configurations other than those described in Embodiment 5 are identical to those described in Embodiments 1 through 4. For convenience of description, members having the functions identical to those illustrated in the drawings of Embodiments 1 through 4 are given the identical reference signs, and descriptions on such members are omitted.

In Embodiment 5, the following discusses an air purifier 20 that includes any one of the gas decomposition filter units 10A, 10B, 10C, and 10D of Embodiments 1 through 4.

With reference to FIG. 11, a configuration of the air purifier 20 of Embodiment 5 including any one of the gas decomposition filter units 10A through 10D is discussed below. FIG. 11 is a perspective view illustrating a configuration of the air purifier 20 of Embodiment 5.

The air purifier 20 of Embodiment 5 is configured to (i) let in air from a front surface or a back surface thereof and (ii) let out air from a top of the air purifier 20 (see FIG. 11). This configuration is of course a mere example and positions at which air is let in/out are not limited to the above configuration. Further, a mechanism for generating an airflow can be a typical one, namely, a fan.

In the air purifier 20 of Embodiment 5, one of the gas decomposition filter units 10A through 10D of Embodiments 1 through 4 is provided in a flow path of air, and thereby the removal target gas, i.e., a harmful gas, in the air is decomposed. A mechanism for decomposing the removal target gas is as described in Embodiments 1 through 4.

The above configuration allows the air purifier 20 of Embodiment 5 to absorb and decompose a harmful gas, and consequently remove odor from air.

Unlike a typical air purifier which is configured to utilize a deodorization filter unit in which only an adsorbent 3a is used for deodorization, the air purifier 20 is arranged to include one of the gas decomposition filter units 10A through 10D of Embodiments 1 through 4 and thereby can not only adsorb a gas but also decompose the gas for deodorization.

Therefore, no life duration is theoretically defined for a deodorization performance, and it is unnecessary to replace a deodorization filter unit.

Note that the air purifier 20 of Embodiment 5 can include, other than any of the decomposition filter units 10A through 10D of Embodiments 1 through 4, a filter unit such as a high efficiency particulate air (HEPA) filter unit for dust removal, a humidifying filter unit for humidification, or the like. Alternatively, the decomposition filter units 10A through 10D of Embodiments 1 through 4 each can be used in combination with an electric-discharge unit or an ion generating unit.

As such, the air purifier 20 is configured to include one of the gas decomposition filter units 10A through 10D of Embodiments 1 through 4. This makes it possible to provide the air purifier 20 which eliminates the need for replacing a deodorization filter unit.

As described above, the air purifier 20 of Embodiment 5 includes one of the gas decomposition filter units 10A through 10D of Embodiments 1 through 4. Therefore, it is possible to provide the air purifier 20 which includes one of the gas decomposition filter units 10A through 10D that can highly efficiently decompose the removal target gas by efficiently irradiating, with light, a spatial range in which the photocatalyst 3b is provided.

[Main Points]

Each of the gas decomposition filter units 10A through 10D in accordance with Aspect 1 of the present invention is a gas decomposition filter unit for decomposing a removal target gas, the gas decomposition filter unit including: gas decomposition pellets 3 including a supported photocatalyst 3b, the gas decomposition pellets 3 allowing gas which contains the removal target gas to flow in a space between the gas decomposition pellets 3; a light source 2 for emitting light with which the gas decomposition pellets 3 are irradiated; a housing 1A or 1B including the gas decomposition pellets 3 and having a mesh side surface wall (mesh 5) at least as a side surface vertical to a direction in which the gas flows, the mesh side surface wall having a mesh size smaller than each of gas decomposition pellets 3; and a light guide member 4A, 4B, or 4C for causing light having entered from the light source 2 to exit toward the gas decomposition pellets 3, the light guide member 4A, 4B, or 4C being provided along at least one direction so as to extend over a spatial range in which the gas decomposition pellets 3 are provided along the side surface of the housing 1A or 1B.

According to the above invention, gas enters from the side surface of the housing through the mesh side surface wall and flows in a space between the gas decomposition pellets.

In the present invention, the light guide member is used so as to irradiate the gas decomposition pellets with light perpendicular to the gas decomposition pellets thoroughly in at least one direction in which the gas decomposition pellets are provided. From this, the light guide member of the present invention is not a point light source but a linear light source which extends in a vertical direction or in a horizontal direction. This makes it possible to irradiate all of the gas decomposition pellets with intense light, thereby leading to a high light irradiation efficiency.

Therefore, it is possible to provide the gas decomposition filter unit which can highly efficiently decompose the removal target gas by efficiently irradiating, with light, a spatial range in which the photocatalyst is provided.

In Aspect 2 of the present invention, each of the gas decomposition filter units 10A through 10D can be arranged such that, in Aspect 1 of the present invention, the gas decomposition pellets 3 further include an adsorbent 3a and are formed by integrally forming the adsorbent 3a and the photocatalyst 3b into pellets in such a manner that the adsorbent 3a and the photocatalyst 3b are in contact with each other.

This makes it possible to (i) adsorb, with the adsorbent, the removal target gas contained in gas which flows in a space between the gas decomposition pellets and (ii) decompose the removal target gas with the photocatalyst. Since the gas decomposition pellets are formed by integrally forming the adsorbent and the photocatalyst into pellets in such a manner that the adsorbent and the photocatalyst are in contact with each other, each of the gas decomposition pellets is in a mass form. This allows the mesh side surface wall of the housing to have a large mesh size, and therefore makes a gas flow in a space between the gas decomposition pellets smoother.

Therefore, it is possible to provide the gas decomposition filter unit which can highly efficiently decompose the removal target gas.

In Aspect 3 of the present invention, each of the gas decomposition filter units 10A through 10D can be arranged such that, in Aspect 2 of the present invention, the absorbent 3a is made of active carbon, zeolite, sepiolite, or a mixture containing at least one of active carbon, zeolite, and sepiolite.

For example, active carbon has an excellent performance in adsorbing many kinds of gas such as benzene gas, lavatory odor, and acetic acid gas. Zeolite and sepiolite have an excellent performance in adsorbing gas, water, etc., and have been used as deodorizing agents.

Therefore, use of active carbon, zeolite, sepiolite, or a mixture containing at least one of active carbon, zeolite, and sepiolite for the adsorbent makes it possible to provide the gas decomposition filter unit which can highly efficiently decompose the removal target gas.

In Aspect 4 of the present invention, each of the gas decomposition filter units 10A through 10D can be arranged such that, in any one of Aspects 1 through 3 of the present invention, the photocatalyst 3b is made of titanium dioxide (TiO₂), tungsten trioxide (WO₃), or a mixture containing at least one of titanium dioxide (TiO₂) and tungsten trioxide (WO₃).

For example, titanium dioxide (TiO₂) has a photocatalytic function with which a VOC gas in the air can be removed by light irradiation and/or offensive odor of ammonium, tobacco, etc. can be decomposed by light irradiation. Tungsten trioxide (WO₃) has a photocatalytic function with which a hard-to-decompose VOC gas can be completely oxidized and decomposed.

Therefore, use of titanium dioxide (TiO₂), tungsten trioxide (WO₃), or a mixture containing at least one of titanium dioxide (TiO₂) and tungsten trioxide (WO₃) makes it possible to provide the gas decomposition filter unit which can highly efficiently decompose the removal target gas.

In Aspect 5 of the present invention, each of the gas decomposition filter units 10A and 10D can be arranged such that, in any one of Aspects 1 through 3 of the present invention, the light guide member 4A has a plate shape.

According to the above configuration, the light guide member having a flat-plate shape is provided so as to be parallel to a gas flow direction. Therefore, the light guide member (i) does not oppose to a gas flow and (ii) serves as a surface light source with respect to the gas decomposition pellets. This makes it possible to irradiate, with light, the spatial range, in which the photocatalyst is provided, throughout the spatial range not only in a height direction but also in a depth direction.

Therefore, it is possible to provide the gas decomposition filter unit which can more highly efficiently decompose the removal target gas.

In Aspect 6 of the present invention, the gas decomposition filter unit 10B can be arranged such that, in any one of Aspects 1 through 5 of the present invention, the light guide member 4B has a wavy-plate shape.

For example, in order to stack the gas decomposition pellets inside the housing at an even density in a height direction, it is preferable to divide the inner space of the housing into layers. However, since the light guide member has a flat-plate shape, it is necessary to provide a partition so as to divide the inner space of the housing into layers. This decreases a filling ratio at which the housing is filled with the gas decomposition pellets.

In the present invention, the light guide member may have a wavy-plate shape. The light guide member having a wavy-plate shape can as a substitute for the partition.

Therefore, it is possible to provide the gas decomposition filter unit which can highly efficiently decompose the removal target gas without decreasing a filling ratio at which the housing 1A is filled with the gas decomposition pellets.

In Aspect 7 of the present invention, the gas decomposition filter unit 10C can be arranged such that, in any one of Aspects 1 through 4 of the present invention, the light guide member 4C has a pillar shape, and the housing 1B has a cylindrical shape.

This makes it possible to provide the light guide member having a pillar shape along an axis of a cylindrical shape of the housing. The gas decomposition pellets are thus present around the light guide member having a pillar shape. This makes it possible to irradiate the gas decomposition pellets with light without loss caused by, for example, reflection which light has been exited from the light guide member.

Therefore, it is possible to provide the gas decomposition filter unit which can highly efficiently decompose the removal target gas in a reduced space.

The air purifier 20 in accordance with Aspect 8 of the present invention includes any one of the gas decomposition filter units 10A through 10D described in Aspects 1 through 7.

Therefore, it is possible to provide the air purifier which includes the gas decomposition filter unit that can highly efficiently decompose the removal target gas by efficiently irradiating, with light, a spatial range in which the photocatalyst is provided.

The present invention is not limited to the description of the embodiments above, but may be altered in various ways by a skilled person within the scope of the claims. Any embodiment based on a proper combination of technical means disclosed in different embodiments is also encompassed in the technical scope of the present invention.

### INDUSTRIAL APPLICABILITY

The present invention is applicable to a gas decomposition filter unit and an air purifier each provided with a photocatalyst.

### REFERENCE SIGNS LIST

1A, 1B Housing
2 Light source
3 Gas decomposition pellet
3a Adsorbent
3b Photocatalyst
4A to 4C Light guide member
5 Mesh (mesh side surface wall)
6 Outer wall
7 Partition
8 Metallic particle
10A to 10D Gas decomposition filter unit
20 Air purifier

1. A gas decomposition filter unit for decomposing a removal target gas,
said gas decomposition filter unit comprising:
gas decomposition pellets including a supported photocatalyst, the gas decomposition pellets allowing gas which contains the removal target gas to flow in a space between the gas decomposition pellets;
a light source for emitting light with which the gas decomposition pellets are irradiated;
a housing including the gas decomposition pellets and having a mesh side surface wall at least as a side surface vertical to a direction in which the gas flows, the mesh side surface wall having a mesh size smaller than each of gas decomposition pellets; and
a light guide member for causing light having entered from the light source to exit toward the gas decomposition pellets, the light guide member being provided along at least one direction so as to extend over a spatial range in which the gas decomposition pellets are provided along the side surface of the housing.

2. The gas decomposition filter unit as set forth in claim 1, wherein the gas decomposition pellets further include an adsorbent and are formed by integrally forming the adsorbent and the photocatalyst into pellets in such a manner that the adsorbent and the photocatalyst are in contact with each other.

3. The gas decomposition filter unit as set forth in claim 2, wherein the adsorbent is made of active carbon, zeolite, sepiolite, or a mixture containing at least one of active carbon, zeolite, and sepiolite.

4. The gas decomposition filter unit as set forth in claim 1, wherein the photocatalyst is made of titanium dioxide (TiO₂), tungsten trioxide (WO₃), or a mixture containing at least one of titanium dioxide (TiO₂) and tungsten trioxide (WO₃).

5. The gas decomposition filter unit as set forth in claim 1, wherein the light guide member has a plate shape.

6. The gas decomposition filter unit as set forth in claim 1, wherein the light guide member has a wavy-plate shape.

7. The gas decomposition filter unit as set forth in claim 1, wherein:
the light guide member has a pillar shape; and
the housing has a cylindrical shape.

8. An air purifier comprising the gas decomposition filter unit as set forth in claim 1.
